(19) United States
(12) Patent Application Publication
(10) Pub. No.: US 2020/0408327 A1
(43) Pub. Date: Dec. 31, 2020

(54) SUBSURFACE VALVE

(71) Applicants: Zhi Yong He, Cypress, TX (US); Carlos Felipe Rivero, Katy, TX (US); Marc Samuelson, Houston, TX (US); Fernando Kirnbauer, Katy, TX (US)

(72) Inventors: Zhi Yong He, Cypress, TX (US); Carlos Felipe Rivero, Katy, TX (US); Marc Samuelson, Houston, TX (US); Fernando Kirnbauer, Katy, TX (US)

(73) Assignee: Baker Hughes Oilfield Operations LLC, Houston, TX (US)

(21) Appl. No.: 16/453,180

(22) Filed: Jun. 26, 2019

(51) Int. Cl. F16K 31/08; F16K 37/00; F16K 31/34

(52) U.S. Cl. CPC F16K 31/082; F16K 31/34; F16K 37/0033

(57) ABSTRACT

A subsurface valve including a valve body having an inlet, and outlet, and a valve portion. A plunger is shiftably mounted in the valve body to selectively fluidically connect the inlet and the outlet. A valve system is arranged in the valve portion. The valve system includes a fixed member comprising a magnet and a moveable member shiftably mounted in the valve body and mechanically connected to the plunger. A control system is operatively connected to the fixed member. The control system is operable to selectively adjust a magnetic flux of the magnet to shift the moveable member and the plunger.

### BACKGROUND

In the resource exploration and recovery industry, valves are employed to control fluid flow into and out from a wellbore. For example, a may be employed in a wellbore to inject fluids, prevent unwanted fluids from reaching a surface of a formation, or the like. Control valves are typically “dumb” valves, e.g., a valve that is controlled by spring force. The valve may be opened or closed by controlling application force to a spring. Thus, the valve will open or close to a specific spring force. Operators cannot control when to open and close or with how much pressure is applied to open or close. The art would be open to valve used in sub-surface applications that could be opened and/or closed with a greater degree of control.

### SUMMARY

Disclosed is a subsurface valve including a valve body having an inlet, and outlet, and a valve portion. A plunger is shiftably mounted in the valve body to selectively fluidically connect the inlet and the outlet. A valve system is arranged in the valve portion. The valve system includes a fixed member comprising a magnet and a moveable member shiftably mounted in the valve body and mechanically connected to the plunger. A control system is operatively connected to the fixed member. The control system is operable to selectively adjust a magnetic flux of the magnet to shift the moveable member and the plunger.

Also disclosed is a resource exploration and recovery system including a first system and a second system including one or more tubulars extending into a formation. The second system is fluidically connected to the first system through the one or more tubulars. At least one of the one or more tubulars supports a tool. A subsurface valve is fluidically connected to the tool. The subsurface valve includes a valve body having an inlet, and outlet, and a valve portion. A plunger is shiftably mounted in the valve body to selectively fluidically connect the inlet and the outlet. A valve system is arranged in the valve portion. The valve system includes a fixed member comprising a magnet and a moveable member shiftably mounted in the valve body and mechanically connected to the plunger. A control system is operatively connected to the fixed member. The control system is operable to selectively adjust a magnetic flux of the magnet to shift the moveable member and the plunger.

Further disclosed is a method of operating a subsurface valve including applying an application force to a magnet to shift a moveable member, shifting a plunger operatively connected to the moveable member relative to an inlet and an outlet to control fluid flow through the subsurface valve, and selectively adjusting the application force to control a magnetic flux of the magnet to control a force applied to the moveable member.

### BRIEF DESCRIPTION OF THE DRAWINGS

The following descriptions should not be considered limiting in any way. With reference to the accompanying drawings, like elements are numbered alike:

FIG. 1 depicts a resource exploration and recovery system including a subsurface valve, in accordance with an exemplary embodiment;

FIG. 2 depicts a valve housing of the subsurface valve of FIG. 1 connected to a tubing encapsulated cable (TEC), in accordance with an aspect of an exemplary embodiment;

FIG. 3 depicts a cross-sectional side view of the subsurface valve, in accordance with an aspect of an exemplary embodiment; and

FIG. 4 depicts a wireframe view of the valve housing of FIG. 2 depicting internal valve components, in accordance with an aspect of an exemplary embodiment.

### DETAILED DESCRIPTION

A detailed description of one or more embodiments of the disclosed apparatus and method are presented herein by way of exemplification and not limitation with reference to the Figures.

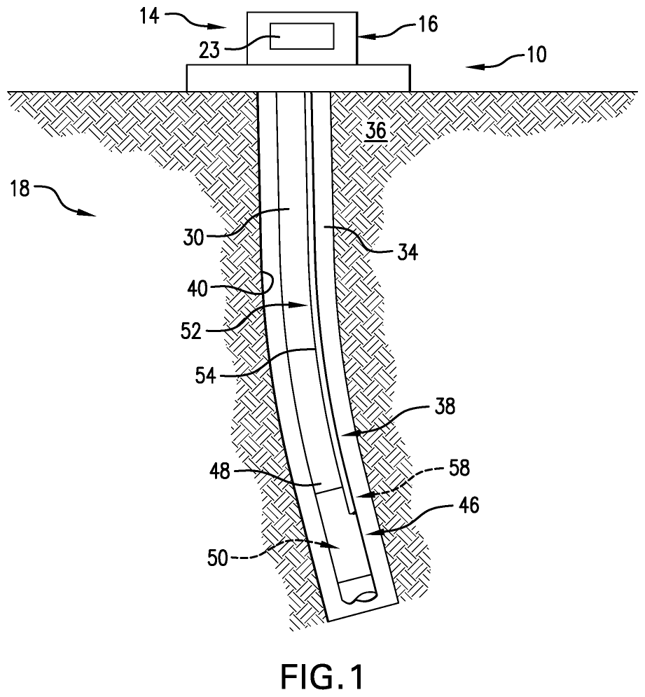

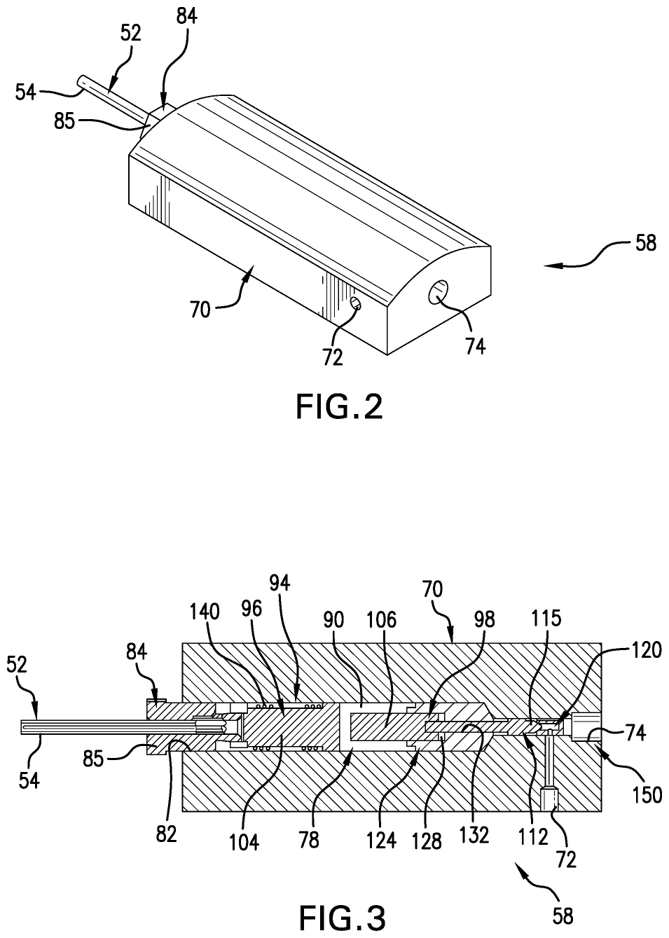

A resource exploration and recovery system, in accordance with an exemplary embodiment, is indicated generally at 10, in FIGS. 1 and 2. Resource exploration and recovery system 10 should be understood to include well drilling operations, completions, resource extraction and recovery, CO₂ sequestration, and the like. Resource exploration and recovery system 10 may include a first system 14 which, in some environments, may take the form of a surface system 16 operatively and fluidically connected to a second system 18 which, in some environments, may take the form of a subsurface system.

First system 14 may include a control system 23 that may provide power to, monitor, communicate with, and/or activate one or more downhole operations as will be discussed herein. Surface system 16 may include additional systems such as pumps, fluid storage systems, cranes and the like (not shown). Second system 18 may include a tubular string 30 that extends into a wellbore 34 formed in a formation 36. Tubular string 30 may take the form of a completion 38 and could be formed from a plurality of interconnected tubulars. Wellbore 34 includes an annular wall 40 which may be defined by a surface of formation 36. Of course, it should be understood, that wellbore 34 may include a casing tubular (not shown).

In an embodiment, tubular string 30 includes a tool 46 mounted to a tubular 48 of tubular string 30. Tool 46 may take the form of a surface controlled subsurface safety valve (SCSSV) 50 that is operatively connected to first system 14 through a control line 52. In an embodiment, control line 52 may take the form of a tubing encased cable (TEC) 54 that is connected to a subsurface valve 58. Subsurface valve 58 may be employed to selectively activate SCSSV 50 by controlling delivery of, for example, a hydraulic fluid.

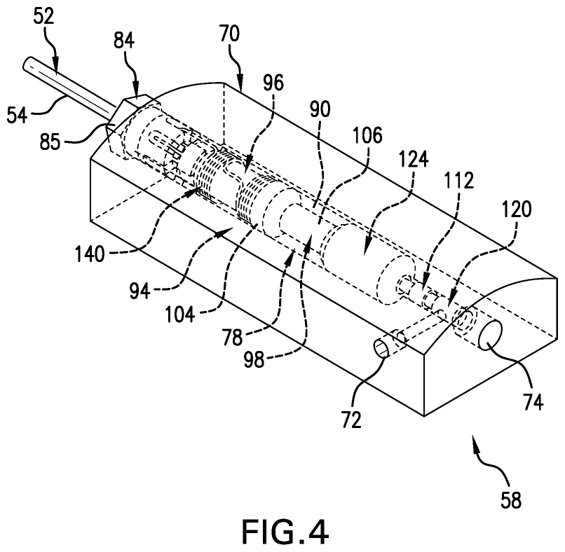

Referring to FIGS. 2-4, subsurface valve 58, in accordance with an exemplary embodiment, includes a valve body 70 including an inlet 72, an outlet 74, a valve portion 78, and a connector portion 82. Connector portion 82 includes a connector 84 that may take the form of a TEC connector 85. Connector 84 provides an interface between control line 52 and subsurface valve 58. Valve portion 78 includes a valve chamber 90 that houses a valve system 94 including a fixed member 96 and a moveable member 98. Fixed member 96 takes the form of a first magnet 104 and moveable member 98 takes the form of a second magnet 106.

In accordance with an exemplary aspect, first and second magnets 104 and 106 are permanent magnets that possess a high magnetic field intensity (H). The term “high magnetic field intensity” should be understood to represent a magnetic field having an intensity (bhmax) of at least about 0.5 Tesla. In an embodiment, the high magnetic field intensity may (bhmax) may be between about 1.6 and about 5.5 kTesla. That is, the permanent magnets may be formed from neodymium, samarium cobalt, or aluminum nickel cobalt.

In further accordance with an exemplary embodiment, moveable member 98 is connected to a plunger 112 that may be selectively shifted to provide an open or close fluid path between inlet 72 and outlet 74. In an embodiment, plunger 112 includes a valve end 115 that may selectively cover and uncover a flow restrictor 120 provided between inlet 72 and outlet 74. Flow restrictor 120 establishes a selected flow pressure from inlet 72 to outlet 74. A crossover fitting 124 may be arranged in valve chamber 90. Crossover fitting 124 includes a recess 128 that may be selectively receptive of moveable member 98 and a passage 132 through which passes plunger 112. Crossover fitting 124 ensures that inlet 72 and outlet 74 are fluidically isolated from valve chamber 90.

In accordance with an exemplary aspect, a conduct coil 140 is arranged about fixed member 96. Conductor coil is operatively connected to connector 84 and control system 23. A pressure sensor 150 may be arranged at outlet 74 to detect fluid pressure. While shown at outlet 74, the position of pressure sensor may vary. In an embodiment, control system 23 may provide an activation current to fixed member 96 through conductor coil 140. The activation current may establish a desired magnetic flux causing moveable member to shift unseating plunger 112 from flow restrictor 120. In another embodiment, the activation current may be provided wirelessly to conductor coil 140 through, for example, a wireless signal, microwave signal, or the like. Sensor 150 may provide feedback to control system 23 regarding flow pressure from subsurface valve 58. Control system 23 may vary the activation current to adjust the magnetic flux to establish a selected flow pressure. In an embodiment, control system 23 may deliver a sinusoidal current to conductor coil 140 to adjust the magnetic flux of moveable member 98.

As an example, the magnetic flux may be adjusted to create a pulling force of moveable member 98 that varies between about 22.4 pounds and about 600 pounds. In this manner, control system 23 may vary the opening force on moveable member 98 to overcome downhole pressures. Thus, subsurface valve system may be employed at any location along wellbore 34 without the need to change springs, spring forces or the like. The subsurface valve may be adjusted without the need for physical changes or rebuilding/replacing valve components. At this point, it should be understood that while described as forming part of a SCSSV, the exemplary, embodiments may be employed with a variety of subsurface tools.

Embodiment 1. A subsurface valve comprising: a valve body including an inlet, and outlet, and a valve portion; a plunger shiftably mounted in the valve body to selectively fluidically connect the inlet and the outlet; a valve system arranged in the valve portion, the valve system including a fixed member comprising a magnet and a moveable member shiftably mounted in the valve body and mechanically connected to the plunger; and a control system operatively connected to the fixed member, the control system being operable to selectively adjust a magnetic flux of the magnet to shift the moveable member and the plunger.

Embodiment 2. The subsurface valve according to any prior embodiment, wherein the moveable member comprises another magnet.

Embodiment 3. The subsurface valve according to any prior embodiment, wherein the magnet comprises a permanent magnet.

Embodiment 4. The subsurface valve according to any prior embodiment, wherein the another magnet comprises a permanent magnet.

Embodiment 5. The subsurface valve according to any prior embodiment, further comprising: a crossover fitting arranged in the valve portion, the cross over fitting including a recess receptive of the moveable member and a passage receptive of the plunger.

Embodiment 6. The subsurface valve according to any prior embodiment, further comprising: a conductor coil extending about the fixed member.

Embodiment 7. The subsurface valve according to any prior embodiment, further comprising: a connector mounted to the valve body, the connector being operatively connected to the conductor coil.

Embodiment 8. The subsurface valve according to any prior embodiment, wherein the connector comprises a tubing encapsulated cable (TEC) connector.

Embodiment 9. The subsurface valve according to any prior embodiment, wherein the plunger is formed from a material that is exposable to formation fluids.

Embodiment 10. The subsurface valve according to any prior embodiment, wherein the fixed member and the moveable member are formed from a material that is distinct from the material that is exposable to formation fluids.

Embodiment 11. The subsurface valve according to any prior embodiment, wherein the fixed member and the moveable member are fluidically isolated from the inlet and the outlet.

Embodiment 12. A resource exploration and recovery system comprising: a first system; a second system including one or more tubulars extending into a formation, the second system being fluidically connected to the first system through the one or more tubulars, at least one of the one or more tubulars supports a tool; and a subsurface valve fluidically connected to the tool, the subsurface valve comprising: a valve body including an inlet, and outlet, and a valve portion; a plunger shiftably mounted in the valve body to selectively fluidically connect the inlet and the outlet; a valve system arranged in the valve portion, the valve system including a fixed member comprising a magnet and a moveable member shiftably mounted in the valve body and mechanically connected to the plunger; and a control system arranged at the first system and operatively connected to the fixed member, the control system being operable to selectively adjust a magnetic flux of the magnet to shift the moveable member and the plunger.

Embodiment 13. The subsurface valve according to any prior embodiment, wherein the moveable member comprises another magnet.

Embodiment 14. The subsurface valve according to any prior embodiment, wherein the magnet and the another magnet comprise permanent magnets.

Embodiment 15. The subsurface valve according to any prior embodiment, further comprising: a crossover fitting arranged in the valve portion, the cross over fitting including a recess receptive of the moveable member and a passage receptive of the plunger.

Embodiment 16. The subsurface valve according to any prior embodiment, further comprising: a conductor coil extending about the fixed member, the conductor coil being operatively connected to the control system.

Embodiment 17. The subsurface valve according to any prior embodiment, further comprising: a connector mounted to the valve body, the connector being operatively connected to the conductor coil.

Embodiment 18. The subsurface valve according to any prior embodiment, wherein the fixed member and the moveable member are fluidically isolated from the inlet and the outlet.

Embodiment 19. A method of operating a subsurface valve comprising: applying an application force to a magnet to shift a moveable member; shifting a plunger operatively connected to the moveable member relative to an inlet and an outlet to control fluid flow through the subsurface valve; and selectively adjusting the application force to control a magnetic flux of the magnet to control a force applied to the moveable member.

Embodiment 20. The method according to any prior embodiment, wherein applying the application force includes passing an activation current through a conductor coiled about the magnet.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another.

The terms “about” and “substantially” are intended to include the degree of error associated with measurement of the particular quantity based upon the equipment available at the time of filing the application. For example, “about” and/or “substantially” can include a range of ±8% or 5%, or 2% of a given value.

The teachings of the present disclosure may be used in a variety of well operations. These operations may involve using one or more treatment agents to treat a formation, the fluids resident in a formation, a wellbore, and/or equipment in the wellbore, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A subsurface valve comprising:
a valve body including an inlet, and outlet, and a valve portion;
a plunger shiftably mounted in the valve body to selectively fluidically connect the inlet and the outlet;
a valve system arranged in the valve portion, the valve system including a fixed member comprising a magnet and a moveable member shiftably mounted in the valve body and mechanically connected to the plunger; and
a control system operatively connected to the fixed member, the control system being operable to selectively adjust a magnetic flux of the magnet to shift the moveable member and the plunger.

2. The subsurface valve according to claim 1, wherein the moveable member comprises another magnet.

3. The subsurface valve according to claim 2, wherein the magnet comprises a permanent magnet.

4. The subsurface valve according to claim 3, wherein the another magnet comprises a permanent magnet.

5. The subsurface valve according to claim 1, further comprising: a crossover fitting arranged in the valve portion, the cross over fitting including a recess receptive of the moveable member and a passage receptive of the plunger.

6. The subsurface valve according to claim 1, further comprising: a conductor coil extending about the fixed member.

7. The subsurface valve according to claim 6, further comprising: a connector mounted to the valve body, the connector being operatively connected to the conductor coil.

8. The subsurface valve according to claim 7, wherein the connector comprises a tubing encapsulated cable (TEC) connector.

9. The subsurface valve according to claim 1, wherein the plunger is formed from a material that is exposable to formation fluids.

10. The subsurface valve according to claim 9, wherein the fixed member and the moveable member are formed from a material that is distinct from the material that is exposable to formation fluids.

11. The subsurface valve according to claim 1, wherein the fixed member and the moveable member are fluidically isolated from the inlet and the outlet.

12. A resource exploration and recovery system comprising:
a first system;
a second system including one or more tubulars extending into a formation, the second system being fluidically connected to the first system through the one or more tubulars, at least one of the one or more tubulars supports a tool; and
a subsurface valve fluidically connected to the tool, the subsurface valve comprising:
a valve body including an inlet, and outlet, and a valve portion;
a plunger shiftably mounted in the valve body to selectively fluidically connect the inlet and the outlet;
a valve system arranged in the valve portion, the valve system including a fixed member comprising a magnet and a moveable member shiftably mounted in the valve body and mechanically connected to the plunger; and
a control system arranged at the first system and operatively connected to the fixed member, the control system being operable to selectively adjust a magnetic flux of the magnet to shift the moveable member and the plunger.

13. The subsurface valve according to claim 12, wherein the moveable member comprises another magnet.

14. The subsurface valve according to claim 13, wherein the magnet and the another magnet comprise permanent magnets.

15. The subsurface valve according to claim 12, further comprising: a crossover fitting arranged in the valve portion, the cross over fitting including a recess receptive of the moveable member and a passage receptive of the plunger.

16. The subsurface valve according to claim 12, further comprising: a conductor coil extending about the fixed member, the conductor coil being operatively connected to the control system.

17. The subsurface valve according to claim 16, further comprising: a connector mounted to the valve body, the connector being operatively connected to the conductor coil.

18. The subsurface valve according to claim 12, wherein the fixed member and the moveable member are fluidically isolated from the inlet and the outlet.

19. A method of operating a subsurface valve comprising:
applying an application force to a magnet to shift a moveable member;
shifting a plunger operatively connected to the moveable member relative to an inlet and an outlet to control fluid flow through the subsurface valve; and
selectively adjusting the application force to control a magnetic flux of the magnet to control a force applied to the moveable member.

20. The method of claim 19, wherein applying the application force includes passing an activation current through a conductor coiled about the magnet.
